(19) United States
(12) Patent Application Publication
(10) Pub. No.: US 2003/0214102 A1
(43) Pub. Date: Nov. 20, 2003

(54) Valve shaft seal for an internal combustion engine

(75) Inventor: Michael Arora, Roletto (IT)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/371,948

(22) Filed: Feb. 20, 2003

(30) Foreign Application Priority Data
Feb. 21, 2002 (DE) 102 07 382.1-13

(51) Int. Cl. F02F 11/00

(52) U.S. Cl. 277/591; 277/596

(57) ABSTRACT

A valve shaft seal for a valve shaft of an internal combustion engine, includes at least one sealing lip of an elastomer material having a first inside diameter and configured to surround the valve shaft and a plurality of projections distributed uniformly around a circumference of the sealing lip and directed toward the valve shaft, a second inside diameter, smaller than the first diameter, being formed by the projections.

### CROSS-REFERENCE TO RELATED APPLICATIONS

This application claims priority to German Patent Application DE 102 07 382.1-13, filed Feb. 21, 2002, which is incorporated by reference herein.

### BACKGROUND

The present invention relates to a valve shaft seal for an internal combustion engine having at least one sealing lip made of an elastomer material surrounding the valve shaft.

One of the problems with valve shaft seals is adequately supplying oil lubricant to the valve shaft. The amount of oil lubricant should be metered as accurately as possible, because both too little oil lubricant as well as an oversupply of oil are undesirable.

U.S. Pat. No. 4,125,265 describes one method of supplying a valve shaft with oil lubricant. In that patent, a gasket having two sealing lips is attached to the valve shaft guide; these lips delimit an annular space, which accommodates oil. Due to the axial movement of the valve shaft, there is a pumping action, so that oil lubricant penetrates between the valve shaft and the valve shaft guide. However, the efficiency of this lubrication and/or sealing is not fully satisfactory.

German Utility Model 90 00 671.2 describes another possibility of controlling the lubricant throughput. Small oil pockets are provided in the surface of the valve shaft in the area of the sealing ring, thus permitting lubrication of the valve shaft. However, this embodiment is not very satisfactory.

Finally, European Patent Application 1 087 108 A1 describes a valve shaft seal, which allows a defined leakage on the machine part moving back and forth and also yields a centered guidance of the sealing lip and the valve shaft. This is achieved by the fact that a plurality of concentric ring bulge sections distributed around the circumference are provided on the interior bottom side of the sealing lip, forming an interrupted centering lip whose inside diameter is larger than the inside diameter of the sealing lip.

### SUMMARY OF THE INVENTION

An object of the present invention is to provide a valve shaft seal, which will yield adequate lubrication of the valve shaft in the dynamic range and will properly seal the valve shaft in the static range. There should be a minimum of oil loss, the leakage rate should be stable and should also be low over the entire lifetime of the product. Furthermore, in machine designs having very narrow tolerances, a greater flow of lubricant through the seal should be possible on startup of the engine than in normal operation. After a short warmup phase, the leakage should be reduced to the desired low level again.

The present invention provides a valve shaft seal for an internal combustion engine, having at least one sealing lip made of an elastomer material surrounding the valve shaft, wherein the sealing lip (5) is provided with a plurality of projections (7) directed toward the valve shaft and distributed uniformly around its circumference, the inside diameter formed by these projections being smaller than the inside diameter of the sealing lip (5). Due to this measure, the sealing lip is at a slight distance from the valve shaft and a larger amount of oil can be supplied to the valve shaft guide than that provided for normal operation. The projections are designed and arranged so that they lift the sealing lip away from the valve shaft only in some sections of the effective area of the projections. The desired throughput of oil lubricant can be determined with a very high precision through the number and shape of the projections.

The projections are designed so that they are worn away after a defined operating time of the engine. This wear process is predetermined by the choice of material. Ultimately, this is influenced by the number and shape of the projections. The projections are preferably conical in shape, which results in the oil flow rate being reduced with increasing wear. In addition, the wear process itself is slowed down.

This novel valve shaft seal yields an increased leakage rate to guarantee adequate lubrication during startup of the engine. After a short warmup time, the leakage rate is reduced to the desired level.

### BRIEF DESCRIPTION OF THE DRAWINGS

The present invention is explained in greater detail on the basis of an exemplary embodiment as illustrated in the accompanying drawings, in which:

FIG. 1 shows a perspective and partially sectional view of a valve shaft seal according to the present invention;

FIG. 2 shows a number of possible different shapes for the projections shown in FIG. 1; and

FIG. 3 shows a detail view of portion D of the valve shaft seal of FIG. 1.

### DETAILED DESCRIPTION

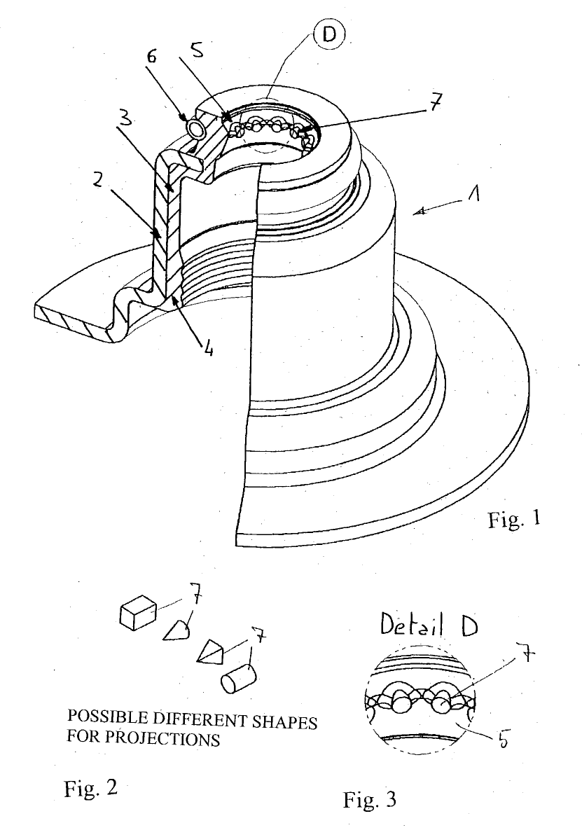

FIG. 1 shows in partially sectional view the perspective diagram of a valve shaft seal 1. Valve shaft seal 1 comprises a retaining element 2 made of sheet metal to which a sealing element 3 is attached. Sealing element 3 is made of a polymer material. It has a static seal 4 with ring bulges with which it is placed on the valve shaft guide (not shown). On its upper end, seal 3 has a sealing lip 5, which is in contact with the valve shaft in the completely assembled state. Sealing lip 5 may additionally be pressed on by ring tension spring 6. A large number of projections 7 are provided on sealing lip 5, the inside diameter formed by these projections, as seen with respect to the axis of the valve shaft, being smaller than the inside diameter of sealing lip 5. Projections 7 may be integrally molded onto sealing lip 5 separately or injected directly in mold. They may be made of a material having a lower wear resistance than sealing lip 5 itself and/or the same material as sealing lip 5.

Projections 7 may be conical and/or linear, as shown in FIGS. 2 and 3. Cylindrical, pyramidal, conical and even cubical embodiments of projections 7 are possible.

What is claimed is:

1. A valve shaft seal for a valve shaft of an internal combustion engine, comprising:
at least one sealing lip of an elastomer material having a first inside diameter and configured to surround the valve shaft; and
a plurality of projections distributed uniformly around a circumference of the sealing lip and directed toward the valve shaft, a second inside diameter being formed by the projections, wherein the second inside diameter is smaller than the first inside diameter.

2. The valve shaft seal as recited in claim 1 wherein the plurality of projections are configured to lift the sealing lip away from the valve shaft only in an area of action of the projections.

3. The valve shaft as recited in claim 1, wherein the plurality of projections are configured to be worn down in a wear process during a defined operating time of the engine.

4. The valve shaft seal as recited in claim 3, wherein the wear process is predetermined by at least one of a number and a shape of the plurality of projections.

5. The valve shaft seal as recited in claim 3, wherein the wear process is at least partially determined by a choice of material.

6. The valve shaft seal as recited in claim 1 wherein the projections include at least one of a conical and linear shape.
